(19) United States
(12) Patent Application Publication
(10) Pub. No.: US 2025/0369275 A1
(43) Pub. Date: Dec. 4, 2025

(54) Charging, Refueling or Service Trough System for a Vehicle with Contactless Sensors, in Particular in the Form of a Radar Device

(71) Applicant: Illinois Tool Works Inc., Glenview, IL (US)

(72) Inventors: Thomas Rader, Pliezhausen (DE); Martha Canelada, Renningen (DE); Roland Och, Rottendorf (DE); Adrian David, Weil der Stadt (DE); Marko Jovanovic, Stuttgart (DE); Matthias Hegwein, Ippesheim (DE); Reza Malekzadeh, Karlsruhe (DE)

(21) Appl. No.: 19/193,656

(22) Filed: Apr. 29, 2025

(30) Foreign Application Priority Data
May 29, 2024 (DE) 10 2024 115 116.1
Jan. 28, 2025 (DE) 10 2025 102 939.3

(51) Int. Cl. E05F 15/73; B60K 15/05; B60L 53/10; B60L 53/16; E05B 81/64; G06V 10/26; G06V 10/764; G06V 10/82; G06V 20/56

(52) U.S. Cl. CPC E05F 15/73; B60K 15/05; B60L 53/11; B60L 53/16; E05B 81/64; G06V 10/26; G06V 10/764; G06V 10/82; G06V 20/56; B60K 2015/0538; B60L 2260/46; E05F 2015/765; E05Y 2400/44; E05Y 2900/534

(57) ABSTRACT

The disclosure relates to a charging, fueling, or service recess system for a vehicle. The charging, fueling, or service recess system includes at least one terminal region or connecting region on which a charging plug or an operating fluid valve can be connected, as required, and a recess body cover with an actuator, said actuator being configured to transfer the recess body cover, as required, from its closed position into its open position and, where relevant, vice versa. The charging, fueling, or service recess system includes a contactlessly operating sensor system which is configured to detect the presence of a charging plug or an operating fluid valve in a detection region which has previously been specified, or can be specified and which surrounds the recess body cover. The charging, fueling, or service recess system further includes a control facility, said control facility being configured, on detecting the presence of a charging plug or an operating fluid valve by the contactless operating sensor system, to generate at least one corresponding message and to output it via an interface, in particular, a user interface and/or to actuate at least one functional component of the charging, fueling, or service recess system.

### RELATED APPLICATIONS

The present application claims the benefit of German Patent Applications No. 10 2024 115 116.1, filed May 29, 2024, and No. 10 2025 102 939.3, filed Jan. 28, 2025, titled “Charging, Refueling or Service Trough System for a Vehicle with Contactless Sensors, in Particular in the Form of a Radar Device,” the contents of which are hereby incorporated by reference.

### BACKGROUND

Vehicles with a hybrid or electromotive drive usually have one battery or traction battery, which, for example in the case of PHEV vehicles (PHEV=plug-in hybrid electric vehicle) or BEV vehicles (BEV=battery electric vehicle), can be charged via an electrical charging port that is accessible from the outside on the vehicle body, and is typically a charging port, by connecting to an electrical charging station, for example, or a conventional external electrical port.

The charging port is usually arranged in a charging well of the vehicle body, which is covered or closed by a charging flap or a charging closure element. A mechanism that cooperates with the charging flap or charging closure element selectively allows the charging well to be opened and closed or the charging flap or charging closure element to be flipped open and closed in relation to the charging well and thus allows access to the charging port.

In vehicles with a combustion-based drive, a fuel tank is supplied with fuel via a refueling filler-neck, which is accessible from the outside by connection to a fuel pump or a refueling nozzle, for example. Corresponding to the charging port, the refueling nozzle is usually arranged in a refueling well assigned to the vehicle body, which is covered or closed by a refueling flap or a refueling closure element. Here, too, a mechanism that cooperates with the refueling flap or refueling closure element selectively allows the refueling well to be opened and closed or the refueling flap or refueling closure element to be flipped open and closed in relation to the refueling well and thus allows access to the refueling filler-neck.

Actuating mechanisms and actuating apparatuses for opening and closing a cover in or on a vehicle are generally known from the prior art, for example from DE 10 2008 057 933 B4, DE 10 2009 060 119 A1, DE 10 2011 101 838 A1, and DE 10 2012 004 078 A1.

Electric and hybrid vehicles are gaining attractiveness through ever increasing ranges. As a result, charging the energy reservoir (battery) of the electric and hybrid vehicles is becoming increasingly important. According to the solutions currently known, the conventional charging apparatuses are fixedly installed in the electric and hybrid vehicles. The user receives for this purpose merely one cable, which is used in order to connect the built-in charging apparatus with a charging station or socket outlet. Current charging apparatuses enable the motor vehicle to be recharged at an electrical outlet, for example at a household socket with a maximum of 2.3 kW or at an AC charging column with, for example, 3.6 kW.

As an additional option, the customer can order an AC wall box for power conversion from AC to DC in the motor vehicle or a DC wall box for power conversion from AC/DC in the wall box to the integrated charging apparatus.

Thus, electric or hybrid vehicles typically have combined charging outlets that can operate on both AC power and DC power. Some plugs only use the AC interface, so that the DC pins remain open during the charging operation and are exposed to weather and environmental conditions. In many cases, in order to protect the unoccupied pins, a manually removable or convertible protection apparatus is used, for example in the form of a cover. Plastic covers having a seal and a hinge and a locking apparatus are also known.

However, with respect to personal protection, it is also desirable that the live components, in particular the electrical contacts of the charging socket, be protected from being touched by a user. For this purpose, additional cover elements are regularly arranged as a cover between the recess body cover (charging flap) and the charging socket.

The disadvantage of the approaches known from the prior art can be seen in particular in the fact that, when charging or preparing a charging operation, the user must always manually remove the protection apparatus for the charging plugs, even when the charging flap of the charging recess is motor-driven.

In addition, the user must always manually operate a corresponding switch so as to enable the charging flap to be moved from its closed position to its open position with the aid of the electromotive actuator. In practice, this means that in order to prepare a charging operation, the user must operate a button or switch, usually located on the charging flap. This is frequently undesirable, because this area of the vehicle is often soiled. Also, the conventional solutions are not suitable for an autonomous charging operation.

This problem exists not only in charging recess systems of the type described above, but also in fueling or service recess systems in particular when they have a plurality of optionally selectable fueling or service ports. Based on this problem, a problem addressed by the disclosure is to specify a system that operates automatically and preferably also independently of the type of charging system, without a user being required to intervene.

### SUMMARY

The present disclosure relates generally to a recess concept in or on a vehicle, substantially as illustrated by and described in connection with at least one of the figures, as set forth more completely in the claims. Specifically, the disclosure relates to an arrangement configured in particular as a charging, fueling, or service recess, which is received or receivable on or in a body or outer skin component of a vehicle.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically an example embodiment of the charging, fueling, or service recess system according to the disclosure, wherein a recess body cover of the charging, fueling, or service recess system is in an open position.

FIG. 2 illustrates schematically and in an isometric view the example embodiment of the inventive charging, fueling, or service recess system according to FIG. 1, wherein the recess body cover is in its closed position.

FIG. 3 illustrates schematically and in an isometric view, the example embodiment of the charging, fueling, or service recess system according to FIG. 2, wherein the recess body cover of the charging, fueling, or service recess system is in an open position.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein is not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent to or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The terms “refueling flap” and “refueling well” as used herein are not understood to mean only the components associated with refueling or the components necessary for refilling a fuel tank. Rather, these terms are also intended to include components for a tank for receiving other resources, for example AdBlue or urea, or an additive such as water. Accordingly, the disclosure also relates to actuating mechanisms for actuating service flaps associated with a filling system for a resource or additive fueling, in particular a fuel, AdBlue, or water tank.

The disclosure further relates to a charging apparatus for a battery of a motor vehicle, in particular an electric or hybrid vehicle, and a corresponding charging system. Furthermore, the disclosure relates to a charging system having a cover, in particular in the form of a charging, fueling, or service flap, and a charging, fueling, or service recess, which is received or receivable on or in a body component of a vehicle, wherein the cover (i.e., the charging, fueling, or service flap in particular) is reversibly movable between a closed position and an open position relative to the charging, fueling, or service recess. Finally, the disclosure further relates to a vehicle having such a charging system.

In one example, a charging, fueling, or service recess system for a vehicle, wherein the charging, fueling, or service recess system comprises: a recess body which can be mounted in or on a bodywork component or an outer skin component; at least one terminal region or connecting region on which a charging plug or an operating fluid valve can be connected, as required, and/or can be at least partially received, wherein the at least one terminal region or connecting region is provided at least partially in an inner region of the recess body; and a recess body cover which can be moved, as required, between a closed position, in which the inner region of the recess body is covered at least partially by the recess body cover, and an open position in which the inner region of the recess body is accessible from outside such that a charging plug or an operating fluid valve can be connected to the at least one terminal region or connecting region and/or can be at least partially received in the at least one terminal region or connecting region, wherein the charging, fueling, or service recess system comprises a contactlessly operating sensor system which is configured to detect the presence of a charging plug or an operating fluid valve in a detection region which has previously been specified, or can be specified and which surrounds the recess body cover, wherein the charging, fueling, or service recess system further comprises a control facility or wherein a control facility is associated with the charging, fueling, or service recess system and is configured, on detecting the presence of a charging plug or an operating fluid valve by the contactless operating sensor system, to generate at least one corresponding message and preferably to output it via an interface, in particular, a user interface and/or to actuate at least one functional component of the charging, fueling, or service recess system.

In some examples, associated with the recess body cover is a mechanism with an, in particular electromotive, actuator which is configured to transfer the recess body cover, as required, from its closed position into its open position and, where relevant, vice versa, wherein the control facility is configured, upon detection by the contactlessly operating sensor system of the presence of a charging plug or an operating fluid valve, to actuate the actuator in such a way that the recess body cover is transferred from its closed position into its open position; and/or wherein associated with the recess body cover is a locking mechanism which is configured to lock the recess body cover in its closed position, as required, wherein the control facility is configured, upon detection by the contactlessly operating sensor system of the presence of a charging plug or an operating fluid valve, to actuate the locking mechanism in such a way that the locking mechanism is transferred into a state unlocking the recess body cover.

In some examples, the contactlessly operating sensor system comprises at least one radar apparatus arranged, partially or in places, behind the recess body cover or behind the bodywork or the outer skin of the bodywork component or the outer skin component.

In some examples, preferably in the region of the radar apparatus, the recess body cover or the bodywork or the outer skin is configured as a radiation window for the radar apparatus, said radiation window preferably being formed from a plastics material.

In some examples, a material permittivity and a dielectric constant of the material of the radiation window are selected such that electromagnetic waves which are emitted and/or received by the radar apparatus can pass through the radiation window almost unattenuated and, in particular, with an attenuation of not more than 10 dB, in particular with an attenuation of not more than 8 dB and, in particular, with an attenuation of not more than 6 dB in a single traversal.

In some examples, the contactlessly operating sensor system is further configured to detect a charging plug type or an operating fluid valve type of a charging plug or an operating fluid valve in the detection region of the sensor system.

In some examples, the control facility is further configured, dependent upon the charging plug type or operating fluid valve type detected by the contactlessly operating sensor system, to generate the at least one corresponding message and preferably to output it via the interface, in particular the user interface and/or to actuate the at least one functional component of the charging, fueling, or service recess system.

In some examples, the control facility is further configured to actuate the actuator, dependent upon the charging plug type or operating fluid valve type detected by the contactlessly operating sensor system, such that the recess body cover is transferred from its closed position into its open position; and/or wherein the control facility is further configured to actuate the locking mechanism such that the locking mechanism is transferred into its state unlocking the recess body cover.

In some examples, wherein the contactlessly operating sensor system is configured to detect, at least indirectly, whether an AC charging plug or a DC charging plug is present in the detection region of the sensor system and wherein the control facility is configured, dependent upon the detection of an AC charging plug or a DC charging plug, to generate a corresponding message and preferably to output it via the interface, in particular the user interface, and/or to actuate the at least one functional component of the charging, fueling, or service recess system.

In some examples, the control facility is further configured to actuate the actuator, dependent upon the detection of an AC charging plug or a DC charging plug, such that the recess body cover is transferred from its closed position into its open position.

In some examples, the contactlessly operating sensor system is configured to detect, at least indirectly, whether a charging plug of the following type is present in the detection region of the sensor system: a type 1 charging plug; and/or a type 2 charging plug; and/or a type 3 charging plug; and/or a CCS1 or combo1 plug; and/or a CCS2 or combo2 plug; and/or a CHAdeMO plug; and/or a Tesla supercharger charging plug; and/or a GB/T charging plug.

In some examples, the contactlessly operating sensor system is configured to detect at least one feature characterizing, in particular, at least a charging plug type, in particular a plug face of a charging plug situated in the detection region of the sensor system and, by means of the at least one feature detected, to draw a conclusion regarding a charging plug type.

In some examples, the contactlessly operating sensor system is configured to detect, at least indirectly, whether an operating fluid valve for fuel or an operating fluid valve for an additive is present in the detection region of the sensor system and wherein the control facility is configured to actuate the actuator, dependent upon the type of the operating fluid valve detected by the contactlessly operating sensor system, such that the recess body cover is transferred from its closed position into its open position.

In some examples, the contactlessly operating sensor system is configured to detect, at least indirectly, whether an operating fluid valve for diesel fuel or an operating fluid valve for gasoline fuel is present in the detection region of the sensor system and wherein the control facility is configured to actuate the actuator, dependent upon the operating fluid valve type detected by the contactlessly operating sensor system, such that the recess body cover is transferred from its closed position into its open position.

In some examples, the contactlessly operating sensor system is configured to detect the diameter of an operating fluid valve situated in the detection region of the sensor system and, by means of the detected diameter, to draw a conclusion regarding an operating fluid valve type.

In some examples, the charging, fueling, or service recess system comprises at least one cover associated with the at least one terminal region or connecting region, said cover being able to be moved between a closed position, in which the at least one terminal region or connecting region is at least partially covered, and an open position in which the at least one terminal region or connecting region is accessible such that a charging plug or an operating fluid valve can be connected to the at least one terminal region or connecting region and/or can be received, at least partially, in the at least one terminal region or connecting region.

In some examples, the control facility is configured to actuate, dependent upon the charging plug type or the operating fluid valve type detected by the contactlessly operating sensor system, a detent associated with the cover and/or an, in particular electromotive, actuator associated with the cover such that the cover is transferred from its closed position into its open position.

In some examples, the charging, fueling, or service recess system comprises a contactlessly operating sensor system which is configured to detect whether, in a previously specified near field region surrounding the recess body cover, a hindrance or an object is present which could impede the transference of the recess body cover from its closed position into its open position, wherein the charging, fueling, or service recess system further comprises a control facility or wherein a control facility is associated with the charging, fueling, or service recess system, said control facility being configured, upon detection of a hindrance or an object in the near field region, to generate at least one corresponding message and preferably to output it via an interface, in particular, a user interface and/or to prevent an actuation of the at least one functional component of the charging, fueling, or service recess system, and in particular, to prevent a transference of the recess body cover from its closed position into its open position.

In some examples, provided in the inner region of the recess body is a charging terminal apparatus for an electrically drivable vehicle, wherein the charging terminal apparatus comprises at least one charging terminal which serves as the terminal region and which is configured as a combined DC/AC charging terminal with AC contact elements and DC contact elements, wherein the charging, fueling, or service recess system comprises a cover which has a covering position and at least two uncovering positions, wherein the uncovering positions of the cover are each associated with a respective charging mode, wherein the cover comprises at least one movably mounted covering element which is able to move between a covering position and at least one uncovering position, wherein in a first uncovering position of the cover, the AC contact elements of the DC/AC charging terminal are uncovered and the DC contact elements of the DC/AC are covered by at least one covering element, wherein in the second uncovering position of the cover, the AC contact elements and the DC contact elements of the DC/AC charging terminal are uncovered.

In some examples, the contactlessly operating sensor system associated with the recess system is configured, dependent upon a charging plug type detected by the contactlessly operating sensor system, to set a position of the cover and, in particular, a position of the at least one covering element, preferably automatically.

In some examples, the contactlessly operating sensor system is configured to detect further states of the charging recess system, in particular at least one position of the recess body cover.

In some examples, the contactlessly operating sensor system is constructed as an imaging sensor system and is configured to generate an at least two-dimensional image of an object present in the detection region of the sensor system.

In some examples, the contactlessly operating sensor system has an evaluating facility or wherein an evaluating facility is associated with the contactless operating sensor system, wherein the evaluating facility is configured to evaluate the at least two-dimensional image generated by the sensor system of the object such that the object is assigned to one of at least two classes, firstly one class which represents a charging plug or an operating fluid valve and, secondly a class for other or unidentified objects.

In some examples, the evaluating facility is configured, for classifying the object from the at least two-dimensional image generated by the sensor system, to extract and/or evaluate at least one feature, in particular a plug face of a charging plug, characterizing, in particular, a charging plug type.

In some examples, the evaluating facility is configured, on the basis of the recognized plug face of the charging plug, to assign the object to a class for a particular plug type, for example, to one of the following classes: a type 1 charging plug; and/or a type 2 charging plug; and/or a type 3 charging plug; and/or a CCS1 or combo1 plug; and/or a CCS2 or combo2 plug; and/or a CHAdeMO plug; and/or a Tesla supercharger charging plug; and/or a GB/T charging plug.

In some examples, in order to evaluate the at least two-dimensional image of the object generated by the sensor system, at least one neural network is used; and/or wherein the at least two-dimensional image of the object generated by the sensor system is evaluated, preferably automatically, with the aid of an artificial intelligence system.

In some examples, wherein, the neural network involves a convolutional neural network, Yolo, in particular YoloV3 or TinyYolo V3, Sweaty or Single-Shot-Multibox-Detector network architecture, and in particular a Single-Shot-Multibox-Detector network architecture.

In some examples, the neural network involves a Single-Shot-Multibox-Detector network architecture that consists of at least five and, in particular, at least seven layers.

In some examples, in the evaluation of the at least two-dimensional image of the object generated by the sensor system, a method of supervised learning is utilized.

In some examples, an evaluating facility is provided which is configured to create, on the basis of external data, vehicle data and/or user data, in particular, in the context of the profiling process, a pattern relating to the utilization behavior over time of the vehicle operator.

In some examples, a control facility is provided which is configured, dependent upon the pattern created, to generate in particular proactively and/or predictively at least one corresponding message and preferably to output it via an interface, in particular a user interface, and/or to actuate at least one functional component of the charging, fueling, or service recess system, wherein the control facility is preferably configured, dependent upon the pattern created, to actuate an actuator of the recess body cover, in particular proactively and/or predictively, such that the recess body cover is transferred from its closed position into its open position, and/or to actuate a locking mechanism associated with the recess body cover such that the locking mechanism is transferred into a state unlocking the recess body cover.

In some examples, the control facility is configured to actuate the actuator of the recess body cover, in particular, proactively and/or predictively, dependent upon the pattern created, such that the recess body cover is transferred from its closed position into its open position if the presence of a charging plug or an operating fluid valve in the detection region of the sensor system is detected by the contactlessly operating sensor system.

In some examples, the evaluating facility is further configured, dependent upon the pattern created relating to the usage behavior over time of the vehicle operator, to generate a statistic and/or a corresponding message and to output it, in particular, to the vehicle operator and/or to the vehicle manufacturer and/or to output it to his sales partners, wherein the message preferably contains a recommendation for an operation of the vehicle optimized, in particular, with regard to a saving of resources.

In some examples, the evaluating facility is configured, in order to create the overall picture relating to the usage behavior over time of the vehicle operator, in particular during a learning or observation phase over at least one observation period and preferably over a plurality of observation periods, to establish a development over time of the usage of the vehicle; and/or to establish a development over time of the consumption of resources by the vehicle.

In some examples, the vehicle data and/or user data comprise, in particular, the following: GPS data; local time of the vehicle; charging/fuel level of the vehicle; and/or day of the week.

In some examples, the evaluating facility is further configured to make use of location data, in particular GPS data of the vehicle in combination with external data, in particular, with stored locations of charging stations, preferably also without usage behavior over time, for an activation of a charging plug recognition and/or a charging plug type recognition and/or for a charging plug recognition and/or a charging plug type recognition.

In some examples, the evaluating facility is configured, according to a model-based method, to segment the at least two-dimensional image generated by the sensor system, wherein in the model-based method, at least one particular form that is specified in advance and, in particular, is machine learnable, of the object contained in the at least two-dimensional image generated by the sensor system is assumed.

In some examples, the evaluating facility is configured, according to a pixel-oriented method, according to an edge-oriented method, according to a region-oriented method, and/or according to a texture-oriented method, to segment the at least two-dimensional image generated by the sensor system in order to extract features of the object contained in the image with regard to shape, size, position, orientation and/or material.

In some examples, the charging, fueling, or service recess system is configured to deactivate the sensor system if the vehicle is in motion and to activate it if the vehicle is standing still, preferably for longer than a predetermined time.

In some examples, associated with the recess body cover is a mechanism with an, in particular electromotive, actuator which is configured to transfer the recess body cover from its closed position into its open position and, if necessary vice versa, as required, wherein the control facility is configured, upon detection by the contactlessly operating sensor system of the presence of a charging plug or an operating fluid valve, to actuate the actuator in such a way that the recess body cover is transferred from its closed position into its open position, wherein the, in particular electromotive, actuator associated with the recess body cover is further configured, in particular, starting from the open position of the recess body cover, in particular as required, to transfer the recess body cover from its open position into an intermediate position between the closed position and the open position, wherein the control facility is configured to detect whether a charging plug or an operating fluid valve is connected to the at least one terminal region or connecting region and/or is at least partially received in the at least one terminal region or connecting region, wherein furthermore, the control facility is configured to actuate the, in particular electromotive, actuator associated with the recess body cover such that, in particular, starting from the open position of the recess body cover, the, in particular electromotive, actuator moves the recess body cover from its open position into the intermediate position.

The vehicle is in particular a vehicle having a hybrid or electric drive, wherein however vehicles having a purely combustion-based drive are not excluded in the context of the present disclosure.

The disclosure relates in particular to a charging, fueling, or service recess system for a vehicle, wherein the charging, fueling, or service recess system comprises a recess body mounted or mountable in or on a body or outer skin component and at least one port or connection region, to which, as needed, a charging plug or a fuel nozzle can be connected or at least partially received. The at least one port or connection region is configured at least regionally in an interior region of the recess body.

The charging, fueling, or service recess system according to the disclosure further comprises a recess body cover, which can be moved as needed between a closed position in which the interior region of the recess body is covered at least regionally by the recess body cover, and an open position in which the interior region of the recess body is accessible from the outside in such a way that a charging plug or a fuel nozzle can be connected to the at least one port or connection region or received at least regionally in the at least one port or connection region.

The recess body cover is in particular associated with a mechanism having a preferably electric motor actuator, which is configured so as to, if necessary, transition the recess body cover from its closed position to its open position and, if necessary, vice versa.

To make the operability of the charging, fueling, or service recess systems more user-friendly, but also in order to configure the charging, fueling, or service recess system for autonomously charging/fueling the vehicle, according to the disclosure, it is provided that the charging, fueling, or service recess system comprises a contactless sensor technology, which is configured so as to detect the presence of a charging plug or a fuel nozzle in a pre-determined or fixed detection range surrounding the recess body cover.

For example, the contactless sensor technology can be a camera system that monitors the area around the recess body cover outside of the vehicle body at predetermined or determinable times and/or events in order to detect whether a charging plug or a fuel nozzle has possibly been inserted in this area (=detection area). This can be done manually by the user, for example; however, it is also conceivable that, as part of an autonomous charging or fueling of the vehicle, a charging plug or a fuel nozzle is guided from a robotic system to the recess system.

In addition to, or in place of, a camera system as contactless sensors, capacitive or inductive sensors are also possible. Ultrasonically-operating sensors are also suitable.

The term “contactless sensor technology” as used herein also includes sensors based on a radio system, in particular an RFID system, in which objects (charging plugs and/or fuel nozzles here) are automatically identified via radio.

Particularly preferably, a radar apparatus is used as the contactless sensor.

The charging, fueling, or service recess system further comprises a control facility. Alternatively, it is also conceivable that the charging, fueling, or service recess system is assigned a corresponding control facility, wherein the control facility is further configured, upon detection of the presence of a charging plug type or fuel nozzle by the contactlessly operating sensor system, to generate the at least one corresponding message and preferably to output it via an interface, in particular the user interface and/or to actuate the at least one functional component of the charging, fueling, or service recess system.

In principle, the control facility can be configured so as to drive the actuator when the contactless operating sensors detect the presence of a charging plug or a fuel nozzle, such that the recess body cover is transferred from its closed position to its open position.

According to conceivable implementations of the charging, fueling, or service recess system, the recess body cover can be associated with a mechanism with an, in particular electromotive, actuator which is configured so as to transfer the recess body cover, as required, from its closed position into its open position and, where relevant, vice versa, wherein the control facility is configured, upon detection by the contactlessly operating sensor system of the presence of a charging plug or a fuel nozzle, to actuate the actuator in such a way that the recess body cover is transferred from its closed position into its open position.

Alternatively or additionally, it is conceivable that associated with the recess body cover is a locking mechanism which is configured so as to lock the recess body cover in its closed position, as required, wherein the control facility is configured, upon detection by the contactlessly operating sensor system of the presence of a charging plug or a fuel nozzle, to actuate the locking mechanism in such a way that the locking mechanism is transferred into a state unlocking the recess body cover.

The advantages achievable with the solution according to the disclosure are clear: by using the contactless sensors, manual intervention by the user is no longer necessary in order to initiate a charging process. The system automatically detects that a charging plug or a fuel nozzle is introduced in the area of the recess body cover, i.e., in the detection area. Then, the recess body cover is automatically transitioned from its closed position to its open position so that the charging plug or the fuel nozzle can be connected to the port or connection area of the charging, fueling, or service recess system.

The charging, fueling, or service recess system is preferably configured so as to deactivate the sensor system if the vehicle is in motion and to activate it if the vehicle is standing still, preferably for longer than a predetermined time (e.g., 20 seconds).

Particularly preferably, the contactlessly operating sensor system is a radar apparatus arranged, partially or in places, behind the recess body cover or behind the bodywork or the outer skin component of the bodywork component or the outer skin component of the vehicle. The advantage of such a radar apparatus can be seen in particular in that with the radar apparatus, the presence of a charging plug or a fuel nozzle in the detection range can be detected independently of the lighting and for the most part also independently of dirt. Moreover, the radar apparatus can be arranged so as to be covered from the A-side of the body or outer skin component.

In particular in the context, it is proposed that preferably at least in the region of the radar apparatus, the recess body cover or the bodywork or the outer skin of the vehicle is configured as a radiation window for the radar apparatus, said radiation window for example being formed from a plastics material. However, the disclosure is not limited to the use of a plastic material for the radiation window.

In principle, it is advantageous that a material permittivity and dielectric constant of the material, in particular the plastic material, of the radiation window are selected such that electromagnetic waves transmitted and/or received from the radar apparatus can preferably pass through the radiation window at least nearly undamped, and in particular with a maximum dampening of 6 dB, in a single pass.

In other words, in the area of the transmitter and the receiver of the radar apparatus, the material covering the radar apparatus outwardly is preferably at least nearly invisible to electromagnetic radar waves.

According to implementations of the charging, fueling, or service recess system according to the disclosure, it is provided that the contactless sensor technology not only detects the presence or absence of a charging plug or a fuel nozzle in the detection range, but is further configured so as to at least indirectly detect a charging plug type or device type of a charging plug or fuel nozzle in the detection range of the sensor technology.

It is proposed that the control facility is further configured so as to actuate the actuator, dependent upon the charging plug type or fuel nozzle type detected by the contactlessly operating sensor system, such that the recess body cover is transferred from its closed position into its open position.

In embodiments of the charging, fueling, or service recess system, the contactlessly operating sensor system is configured so as to detect a charging plug type or a fuel nozzle type of a charging plug or a fuel nozzle in the detection region of the sensor system. It is conceivable in this context, for example, that the control facility is configured, dependent upon the charging plug type or fuel nozzle type detected by the contactlessly operating sensor system, to generate the at least one corresponding message and preferably to output it via the interface, in particular the user interface and/or to actuate the at least one functional component of the charging, fueling, or service recess system.

In other words, only if it is detected that a charging plug compatible with the port or connection area of the charging, fueling, or service recess system or a correspondingly compatible fuel nozzle in the detection range of the sensor is present, the control facility allows the recess body cover to be converted from its closed position to its open position.

In particular, the control facility is configured so as to actuate, dependent upon the charging plug type or the fuel nozzle type detected by the contactlessly operating sensor system, the actuator such that the recess body cover is transferred from its closed position into its open position. Alternatively, or additionally, the control facility is configured so as to actuate the locking mechanism such that the locking mechanism is transferred into its state unlocking the recess body cover.

In a further development of the last-named design variant, it is provided that the contactless sensor technology is configured so as to at least indirectly detect whether an AC charging plug or a DC charging plug is present in the detection range of the sensor technology. The control facility controls the actuator of the recess body cover only when it is detected that the charging plug identified by the sensor technology and present in the detection range is compatible with the port or connection area of the charging, fueling, or service recess system.

In a further development of this embodiment in particular, it is provided that the contactless sensor technology is configured so as to at least indirectly detect whether a charging plug of the following type is present in the detection range of the sensor technology: a type 1 charging plug; a type 2 charging plug; a type 3 charging plug; a CCS1 or combo1 plug; a CCS2 or combo2 plug; a CHAdeMO plug; a Tesla supercharger charging plug; and/or a GB/T charging plug.

The type 1 charging plug is predominantly used in North America and Asia. This is a single-phase plug. It has a maximum charging power of 7.4 kW.

The type 2 charging plug is predominantly found in Europe. It is also called a Mennekes plug. In January 2013, the European Commission specified the plug type with the designation EN 62196 type 2 as the standard in the EU. At a wall box at home, an electric vehicle with a type 2 plug can typically be charged with a charging power of up to 22 kW. At public charging stations with type 2 charging outlets, even fast charging with up to 43 kW power is possible.

Type 3 electric vehicle charging plugs came about at the same time as the type 2 plug. There are two variants of this: the type 3A for single-phase charges up to 7.4 kW and the type 3C for three-phase charges up to 43 kW charging current.

CCS plugs or combo plugs relate to charging plugs for a combined fast charging system, which is also called “combo.” There are type 1 and type 2 for this purpose. In a CCS charging cable, the plug is divided into two areas: the upper part corresponds to a type 1 or type 2 port. The lower part of a combo plug is for DC charging.

CHAdeMO charging plugs for electric vehicles are from Japan. This type of plug is designed for fast charging of a DC-powered vehicle and charges at an output of 50 to 100 kW depending on the charging station.

With the supercharger charging plug, TESLA has developed its own charging plug that resembles the type 2 plug.

The contactlessly operating sensor system is configured in particular to detect at least one feature characterizing, in particular, at least a charging plug type, in particular a plug face of a charging plug situated in the detection region of the sensor system and, by means of the at least one feature detected, to draw a conclusion regarding a charging plug type.

According to implementations of the disclosure, so that the corresponding charging plug type can be reliably detected by the contactless sensor technology, it is thus provided that the contactless sensor technology is configured so as to detect, for example, the plug face of a charging plug located in the detection range of the sensor technology and to infer a charging plug type via the detected plug face. This indirect detection of the charging plug type has proven to be particularly reliable in practical experiments.

A male face is preferably understood herein as a side of the charging plug inserted into the charging socket. This side is characteristic of a particular charging plug type due to its particular arrangement and diameter of metallic contact pins or sockets and/or plastic walls, which are defined partly by standards.

The present disclosure thus also relates in particular to recess systems, in particular charging recess systems, which comprise a plurality of port areas or connection areas, each of which are accommodated in an interior region of the recess body of the recess system.

The disclosure is based on the finding that in some applications, a charging port for an electrically driven vehicle with two charging ports arranged adjacent to one another with a first DC charging port and a second DC and/or AC power port is needed.

For example, it is contemplated that in the connection area of the charging recess system, two charging ports are provided with a first DC charging port and a second DC current and/or AC charging port arranged adjacent to each other. For this purpose, it can be appreciated that the charging recess system comprises a charging port cover associated with the connection area, which covers at least one of the two charging ports. In particular, the charging port cover is configured such that only one of the two charging ports is accessible for contact, while the other of the two charging ports is covered by the charging port cover.

Vehicles based on an electric drive thus often require their own charging port for each charging standard, and therefore, two charging ports are also provided on the vehicle, usually for two charging possibilities of different standards.

For example, the current charging standard used in Europe is the so-called combined charging system (CCS).

Charging with DC current and alternating current is possible here. Another standard CHAdeMO=“Charge de Move,” as a standard developed in Japan, offers a charging power of up to 50 kW.

For alternative or future charging standards with powers of several 100 KW or even above with leads of at least one megawatt and more, a further charging port, in particular a DC voltage port, is provided according to a further, alternative plug standard. A plurality of charging ports can be electrically connected in one path so that the charging ports/doses are energized simultaneously.

In a recess system according to one aspect of the present disclosure, it is thus provided that a charging port apparatus for an electrically driven vehicle is provided in the interior area of the recess body, wherein the charging port apparatus comprises at least one charging port, which serves as the connection area, and which is configured as a combined DC-AC charging port with AC contact elements and DC contact elements.

It can be appreciated that the charging port apparatus or the charging recess system comprises a cover, which has a covering position and the at least two releasing positions, wherein the releasing positions of the cover are each associated with a charging mode. The cover comprises at least one movably supported cover element, which is movable between a covering position and at least one releasing position. In a first releasing position of the cover, the AC contact elements of the AC/DC charging port are released and the DC contact elements of the AC current are covered by at least one cover element. In the second releasing position of the cover, the AC contact elements and the DC contact elements of the AC/DC charging port are released. In the covering position of the cover, the charging ports are covered by the at least one cover member.

In this context, it is proposed that the contactlessly operating sensor system associated with the recess system is configured, dependent upon a charging plug type detected by the contactlessly operating sensor system, to set a position of the cover and, in particular, a position of the at least one covering element, preferably automatically. In other words, preferably, the contactless sensors are configured so as to release either the AC contact elements of the AC/DC charging port or the same current contact elements of the AC/DC charging port, depending on the type of charging plug detected.

However, the disclosure is not limited to recess systems but also relates to fueling or service recess systems.

In this respect, according to further developments of the disclosure, it is provided that the contactless sensor technology is configured so as to at least indirectly detect whether a fuel nozzle for a fuel or a fuel nozzle for an additive, for example water or AdBlue, is present in the detection range. In particular, the sensor technology is also configured so as to distinguish between a fuel nozzle for gasoline fuel and a fuel nozzle for diesel fuel.

The contactless sensors sense the diameter of the fuel nozzle and draw conclusions about the fuel nozzle type over the determined diameter.

According to a further aspect of the disclosure, the charging, fueling, or service recess system comprises a contactlessly operating sensor system which is configured so as to detect whether, in a previously specified near field region surrounding the recess body cover, a hindrance or an object is present which could impede the transference of the recess body cover from its closed position into its open position, wherein the charging, fueling, or service recess system further comprises a control facility or wherein a control facility is associated with the charging, fueling, or service recess system, said control facility being configured, upon detection of a hindrance or an object in the near field region, to generate at least one corresponding message and preferably to output it via an interface, in particular, a user interface and/or to prevent an actuation of the at least one functional component of the charging, fueling, or service recess system, and in particular, to prevent a transference of the recess body cover from its closed position into its open position.

According to a further aspect of the disclosure, the charging, fueling, or service recess system comprises a cover associated with the at least one port or connection region, which can be moved between a closed position in which the at least one port or connection region is covered at least regionally and an open position in which the at least one port or connection region is accessible in such a way that a charging plug or a fuel nozzle can be connected to the at least one port or connection region or received at least regionally in the at least one port or connection region.

The connection or receipt of the charging plug or the fuel nozzle in the corresponding port or connection area can occur manually by the user but also autonomously by a robot system.

In this context, it is proposed that the control facility is configured so as to control a detent associated with the cover and/or an in particular electromotive actuator associated with the cover in a manner that is dependent on the charging plug type or the fuel nozzle type detected by the contactless sensor technology, in such a way that only then the cover associated with the at least one connection area is converted to its open position, when it is sensed by the contactless operating sensors in the detection range that there is a charging plug compatible with the corresponding port or connection area or a fuel nozzle compatible with the corresponding port or connection area.

The disclosure is based on the finding that electric or hybrid vehicles typically have combined charging outlets that can operate on both AC power and DC power. Some charging plugs only use the AC interface, so that the DC interface, and in particular the DC pins, are to remain closed during the charging process.

With the last-mentioned design variant, it is thus ensured that only the port or connection area of the charging, fueling, or service recess system can be used, for which the “correct” charging plug or the “correct” fuel nozzle is present in the detection range of the sensor technology. The solution enables an increase in the comfort of a vehicle user because the charging process, and in particular the insertion of the correct charging plug into the port or connection region of the charging recess system, can be carried out automatically or in a piloted manner.

Thus, an optimized charging interface for a charging system serving an electrically driven or drivable vehicle is provided overall, wherein the charging system is in particular improved with regard to an automatic or piloted charging process.

For operational safety, the contactless operating sensor technology can be further configured so as to detect whether an obstruction or an object that could interfere with the transfer of the recess body cover is present in a pre-determined near field region surrounding the recess body cover.

In such a situation, the control facility would prevent the electromotive actuator associated with the recess body cover from being actuated or the recess body cover being transitioned from its closed position to the open position.

In particular, the contactless sensor technology is also configured so as to sense further states of the charging recess system, for example a position of the recess body cover.

According to preferred implementations of the charging, fueling, or service recess system according to the disclosure, the contactlessly operating sensor system is constructed as an imaging sensor system and is configured so as to generate an at least two-dimensional image of an object present in the detection region of the sensor system.

The imaging sensor technology is in particular a sensor technology based on radar technology, which is very well suited for this purpose, because the metallic contact pins or sockets of a male face are thus prominent in the image created, although other design variants are also possible. In particular, push broom scanners, CMOS image sensors, laser triangulation sensors, laser light section sensors, 3D sensors, infrared sensors, ultrasonic sensors, cameras, and X-ray sensors are also suitable imaging sensors.

According to further developments of the last-mentioned design variant, the contactless sensor system comprises an evaluation device. Alternatively, however, it is also conceivable that the contactless sensor technology is associated with an evaluation device.

The evaluation device is configured so as to evaluate the at least two-dimensional image of the object generated by the sensor technology in such a way that the object is assigned to one of at least two classes, on the one hand a class that represents a charging plug or (if applicable) fuel nozzle that is preferably compatible with the vehicle and on the other hand, a class for other or unidentified objects.

In this context, in particular, it is provided that the evaluation device is configured so as to classify the object from the at least two-dimensional image generated by the sensor technology in order to detect a plug face of a charging plug, for example, by detecting the metallic contact pins or sockets characteristic for a male face, based on the number and/or the arrangement (e.g., intermediate spacings, length, diameter of the contact pins or bushings—each absolute or preferably relative) of the contact pins or bushings to each other.

According to preferred implementations, it is provided in this context that the evaluation device is configured so as to classify the object into a class for a particular type of charging plug (e.g., according to a particular standard) based on the detected male face of the charging plug, e.g., into one of the following classes, e.g., as a subclass to the aforementioned class for a charging plug: a type 1 charging plug; a type 2 charging plug; a type 3 charging plug; a CCS1 or combo1 plug; a CCS2 or combo2 plug; a CHAdeMO plug; and/or a Tesla supercharger charging plug; and/or a GB/T charging plug.

To evaluate the at least two-dimensional image of the object generated by the sensor technology, preferably at least one neural network is used.

By using at least one neural network to evaluate the captured image, a particularly fast and accurate, but nonetheless memory-sensitive, object detection system is achievable. Preferably, this system includes not only detecting and classifying an object in an image, but also locating and/or determining details of an object, such as contact pins or sockets of the plug face, such as by: drawing corresponding bounding boxes, and/or determining one or more parameters of the male face (e.g., number and/or arrangement such as intermediate spacing, length, diameter of the contact pins or sockets—each absolute or preferably relative), and/or comparing known sub-objects (from training data, e.g., male faces) with regions within the detected object.

According to preferred implementations of the optical detection system, the neural network is a CNN (Convolutional Neural Network), Yolo, or SSD network architecture. In particular, a YoloV3, TinyYoloV3, or sweaty network architecture is well-suited for object detection and classification in charging, fueling, or service recess systems, although particularly good results are achieved with a Single Shot MultiBox Detector (SSD) network architecture.

Similar to a Yolo network architecture, an SSD network architecture also uses a single Deep Neural Network for real-time object detection. The difference compared to Yolo is the classification. For this purpose, an SSD does not use a fully-connected layer, but rather a convolutional layer. Initially, the input image passes through a standard CNN, which is disconnected prior to the classification layer. For the actual detection, further convolutional layers will follow, with which feature maps having different resolutions m×n and p channels will be generated.

When evaluating the at least one captured image of the particular charging plug to be classified, algorithms are in particular systematically applied to determine the underlying relationship between the data and the information by using a machine learning method. The feature of particularly monitored machine learning is to find a function that generalizes from a training experience and outputs a hypothesis regarding similar data. The key difference between machine learning and simple interpolation consists of this step of generalization.

A CNN network architecture is a deep learning architecture that has great potential in optical charging plug or fuel nozzle detection in charging, fueling, or service recess systems in locating and classifying individual contact ports of a plug face in images. Similar to regular artificial neural networks, CNN network architectures also consist of neurons with learnable weights and biases. The difference lies in the input. These explicitly consist of images in CNN network architectures, allowing the architecture to be adjusted accordingly. The result is an increase in feedforward pass efficiency and reduction of network parameters.

According to preferred embodiments of the charging, fueling, or service recess system according to the disclosure, the neural network is an SSD network architecture consisting of 7 layers, and occasionally referred to as the “SSD7 network architecture.”

By contrast to the original SSD network architecture, a prior CNN is not used for the SSD7 network architecture. The construction is carried out with only seven layers (seven convolutional layers).

The input image passes through these seven layers, with the last four layers generating so-called feature maps of different resolution. These serve as input for the layers for detection. When the detections are generated, the features are classified from the four feature maps, and box coordinates are generated. The result is a variety of detections, several per class with different confidence scores and box coordinates. A decoding is performed, which, due to the plurality of detections, includes a filtering of these. First, with a so-called confidence threshold, the classes that are above this threshold are filtered out. A non-maximum suppression per class with an IoU threshold value follows. The detected box with the highest confidence score is selected, and any boxes around it that are too close to it are removed, measured against the IoU threshold. A last threshold value indicates how many detections remaining are included in the final detections. All stated thresholds are determined experimentally using the monitored learning method.

In the method according to the disclosure for optical charging plug or fuel nozzle detection, at least a two-dimensional image of at least a part of the charging plug or fuel nozzle is first taken using an optical detection system, or this part is extracted from a captured image (e.g., radar image). This relates in particular to the plug face of the charging plug or the fuel nozzle.

Then, the at least one captured image or the extracted image portion is evaluated using an evaluation device such that, in the at least one captured image or partial image, individual features, such as contact pins or sockets, or groups of individual features are located and classified. The method according to the disclosure for optical charging plug or fuel nozzle detection is wherein at least one neural network is used in order to evaluate the at least one captured image, wherein this at least one neural network is preferably a Single Shot MultiBox Detector network architecture, and in particular a Single Shot MultiBox Detector network architecture consisting of 7 layers.

In particular, when evaluating the at least two-dimensional image of the object generated by the sensor technology, a method of monitored learning can be exploited.

Example: A SSD7 network is used as the neural network. This is a simplified Single Shot MultiBox Detector network architecture composed of seven layers. Between 500-2,500 images are captured for training the SSD7 network. These show different objects in the detection range of the sensors, in particular charging plugs having different plug faces. The evaluation of the SSD7 network is done with a separate image set consisting of 70 images, not used for training. Different charging plug types are placed in the detection range of the sensors, which were not used for the training of the SSD7 network. This measure is intended to determine how well the network generalizes the training images.

This can be used in order to show at what detection rate with the SSD7 network an optical charging plug detection is possible in the form of a localization and classification of the individual contact ports of the charging plug.

According to implementations of the optical charging plug detection system, it is provided that the evaluation device is designed for, in particular, optional preprocessing of at least a two-dimensional image recorded by the sensor system, for object detection purposes, in particular with neural networks of the, in particular, optionally preprocessed image, and for feature extraction and classification of objects contained in the image.

In particular, it is provided in this context that the evaluation device is designed to perform object detection with neural networks on the at least one preprocessed image, according to a model-based method, wherein the model-based method assumes a predetermined or, in particular, machine-learnable, specific shape and/or a predetermined or in particular machine-learnable plug face of the objects contained in the image.

Alternatively or additionally, the evaluation device is designed to perform object detection with neural networks on the image, in particular an optionally preprocessed image, according to a pixel-oriented method, according to an edge-oriented method, according to a region-oriented method, and/or according to a texture-oriented method, in order to extract features of the objects contained in the image with regard to their shape, size, position, orientation, and/or material.

According to a further aspect of the present disclosure, the charging, fueling, or service recess system comprises an evaluation device which is configured so as to create, on the basis of external data, vehicle data and/or user data, in particular, in the context of the profiling process, a pattern relating to the utilization behavior over time of the vehicle operator.

With this aspect, an entirely new approach, not yet known from the prior art, is pursued. In particular, the charging, fueling, or service recess system according to the disclosure has a certain amount of “intelligence,” because artificial knowledge is generated from experience with the aid of the evaluation device.

The evaluation device learns in particular from examples during the learning or observation phase and can generalize them after the learning phase has been completed. To this end, algorithms of the evaluation device in machine learning build a statistical model that is based on training data that was generated in particular during the learning or observation phase. These training data are preferably continuously tested against new data (test data) after the end of the learning or observation phase.

In other words, according to embodiments of the present disclosure, the evaluation device of the charging, fueling, or service recess system does not simply memorize the examples gained during the learning or observation phase, but preferably recognizes patterns and regularities in the learning data. For example, due to these patterns or regularities, the detection rate can be increased (e.g., the vehicle will stop at a location localized by GPS data, on which it has already been charged one or more times with a specific charging plug—the purely image-based detection threshold for that charging plug is then reduced), or the time delay of activation of the sensors is adjusted after a stoppage of the vehicle (e.g., the sensors start immediately after a stoppage of the vehicle or after a shortened time interval compared to a stoppage at another location, if a stop at a charging station is detected based on patterns or regulations or GPS data).

After a certain learning procedure during the learning or observation phase, this allows the charging, fueling, or service recess system according to the disclosure to be optimally adapted or adaptable to the respective application or to the respective usage behavior of the vehicle operator.

In particular, the detected usage behavior of the vehicle operator can also be used in order to drive the actuator of the recess body cover. This is preferably done in combination with the optical detection system.

For example, it is conceivable that the control facility of the charging, fueling, or service recess system is configured so as to actuate the actuator of the recess body cover, in particular, proactively and/or predictively, dependent upon the pattern created, such that the recess body cover is transferred from its closed position into its open position if the presence of a charging plug or a fuel nozzle in the detection region of the sensor system is detected by the contactlessly operating sensor system.

Alternatively, or additionally, it is conceivable that the evaluation device is configured so as to generate statistics and/or a corresponding notification as a function of the created pattern relating to the temporal usage behavior of the vehicle operator and to output this to the vehicle operator in particular and/or to the vehicle manufacturer and/or its sales partner. For example, the notification can include a recommendation for an operation of the vehicle that is optimized, particularly with regard to resource savings.

To create the overall pattern relating to the vehicle operator's temporal usage behavior, the evaluation device is in particular configured so as to, preferably during a learning or observational period, determine a temporal evolution of use of the vehicle over at least one observation period and preferably over a plurality of observation periods, a temporal evolution of the consumption of resources of the vehicle, and/or a timing of charging operations of the vehicle.

For this purpose, GPS data of the vehicle, the corresponding local time of the vehicle during a charging operation, the charging state/fueling state of the vehicle, and/or the day of the week are used as external data or vehicle data and/or user data.

Thus, it is contemplated that the evaluation device “knows” that the vehicle is usually recharged at a particular charging station at a particular time of day. With this “knowledge,” the control facility can be further sensitized to drive the actuator of the recess body cover accordingly, if necessary.

Preferably, the evaluation device is configured so as to use location data, in particular GPS data, of the vehicle in combination with external data (e.g., stored locations of charging stations), preferably also without time-usage behavior, for activation of the detection and/or for the detection. For example, it is detected when the vehicle is present in a location, localized by GPS, for which a charging station is stored. Then, the sensor system is activated immediately or after a time interval shortened in comparison to other locations and/or the image-based detection threshold for a charging plug, preferably for the charging plug type, which allocates the external data of that charging station, is then lowered.

The example embodiment of the charging, fueling, or service recess system 1 as illustrated in the drawings comprises a recess body 2 which can be mounted in or on a body work component or an outer skin component of a vehicle.

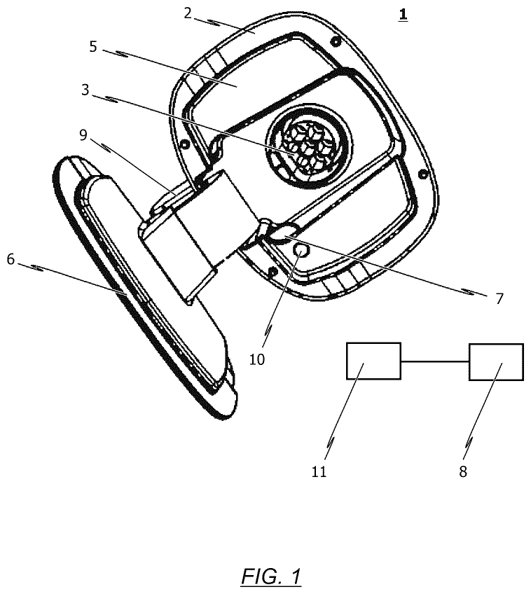

FIG. 1 illustrates schematically an example embodiment of the charging, fueling, or service recess system according to the disclosure, wherein a recess body cover of the charging, fueling, or service recess system is in an open position. As illustrated, for example, in FIG. 1, the charging, fueling, or service recess system 1 further comprises a terminal region or connecting region 3 on which a charging plug 4 can be connected, as required, wherein the terminal region or connecting region 3 is provided in an inner region 5 of the recess body 2.

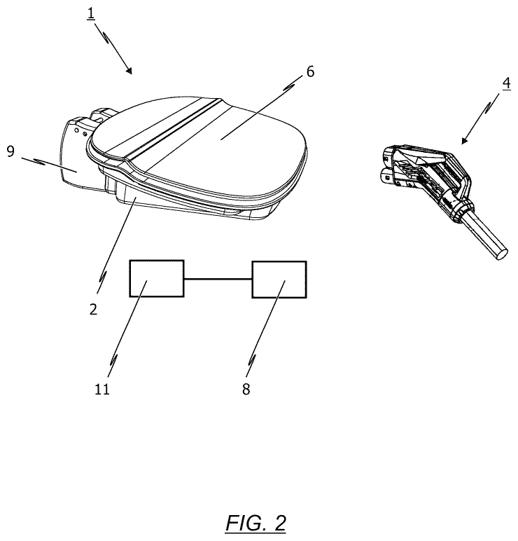

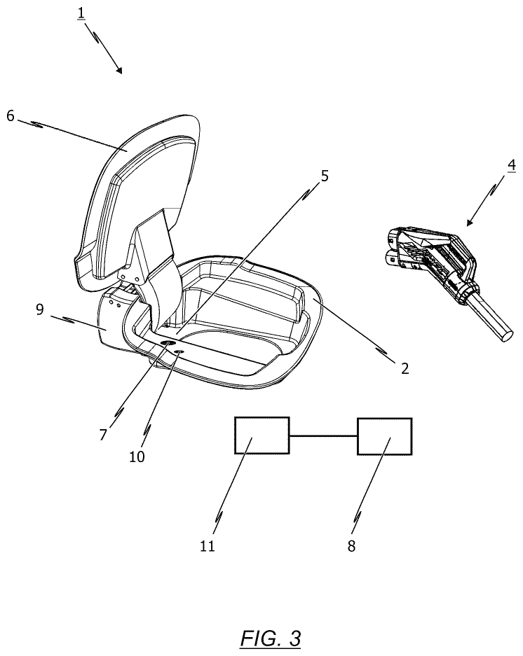

FIG. 2 illustrates schematically and in an isometric view the example embodiment of the inventive charging, fueling, or service recess system according to FIG. 1, wherein the recess body cover is in its closed position, while FIG. 3 illustrates schematically and in an isometric view, the example embodiment of the charging, fueling, or service recess system according to FIG. 2, wherein the recess body cover of the charging, fueling, or service recess system is in an open position.

The charging, fueling, or service recess system 1 further comprises a recess body cover 6 which can be moved, as required, between a closed position (see FIG. 2), in which the inner region 5 of the recess body 2 is covered by the recess body cover 6, and an open position in which the inner region 5 of the recess body 2 is accessible from outside such that a charging plug 4 can be connected to the terminal region or connecting region 3.

As further indicated in the drawings, the inventive charging, fueling, or service recess system 1 further comprises a contactlessly operating sensor system 7 which is configured to detect the presence of a charging plug 4 in a detection region which has previously been specified, or which can be specified and which surrounds the recess body cover 6.

In addition, the charging, fueling, or service recess system 1 comprises a control facility 11 in the form of a micro-controller, which is configured, on detecting the presence of a charging plug 4 by the contactlessly operating sensor system 7, to generate at least one corresponding message and to output it via an interface 8.

The charging, fueling, or service recess system 1 further comprises a mechanism 9 that is associated with the recess body cover 6, wherein the mechanism 9 comprises an actuator which is configured to transfer the recess body cover 6, as required, from its closed position into its open position and, where relevant, vice versa.

The control facility 11 is particularly configured, upon detection by the contactlessly operating sensor system 7 of the presence of a charging plug 4, to actuate the actuator in such a way that the recess body cover 6 is transferred from its closed position into its open position.

As illustrated, for example, in FIG. 1, a locking mechanism 10 is associated with the recess body cover 6, wherein the locking mechanism 10 is configured to lock the recess body cover 6 in its closed position, as required, wherein the control facility 11 is configured, upon detection by the contactlessly operating sensor system 7 of the presence of a charging plug 4, to actuate the locking mechanism 10 in such a way that the locking mechanism 10 is transferred into a state unlocking the recess body cover 6.

The contactlessly operating sensor system 7 particularly comprises a radar apparatus arranged behind the recess body cover 6.

The contactlessly operating sensor system 7 is further configured to detect a charging plug 4 type of a charging plug 4 in the detection region of the sensor system 7. In this context, the control facility 11 is further configured, dependent upon the charging plug 4 type detected by the contactlessly operating sensor system 7, to generate at least one corresponding message and to output it via the interface 8.

While the present method and/or system have been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A charging, fueling, or service recess system for a vehicle comprising:
a recess body configured to mount in or on a bodywork component or an outer skin component of the vehicle;
at least one terminal region or connecting region on which a charging plug or an operating fluid valve can be connected and/or can be at least partially received,
wherein the at least one terminal region or connecting region is provided at least partially in an inner region of the recess body;
a recess body cover configured to move between a closed position in which the inner region of the recess body is covered at least partially by the recess body cover, and an open position in which the inner region of the recess body is accessible from outside such that a charging plug or an operating fluid valve can be connected to the at least one terminal region or connecting region and/or can be at least partially received in the at least one terminal region or connecting region; and
a contactlessly operating sensor system configured to detect the presence of a charging plug or an operating fluid valve in a detection region which has previously been specified, or can be specified and which surrounds the recess body cover,
wherein a control facility associated with the charging, fueling, or service recess system is configured, upon detecting the presence of a charging plug or an operating fluid valve by the contactless operating sensor system, to generate at least one corresponding message and to output it via a user interface and/or to actuate at least one functional component of the charging, fueling, or service recess system.

2. The charging, fueling, or service recess system according to claim 1,
wherein, associated with the recess body cover, is a mechanism with an actuator that is configured to transfer the recess body cover between its closed position and its open position, wherein the control facility is configured, upon detection by the contactlessly operating sensor system of the presence of a charging plug or an operating fluid valve, to actuate the actuator such that the recess body cover is transferred from its closed position into its open position; and/or
wherein, associated with the recess body cover, is a locking mechanism that is configured to lock the recess body cover in its closed position, wherein the control facility is configured, upon detection by the contactlessly operating sensor system of the presence of a charging plug or an operating fluid valve, to actuate the locking mechanism such that the locking mechanism is transferred into a state unlocking the recess body cover.

3. The charging, fueling, or service recess system according to claim 1,
wherein the contactlessly operating sensor system comprises at least one radar apparatus arranged at least partially behind the recess body cover, the bodywork, the outer skin of the bodywork component, or the outer skin component.

4. The charging, fueling, or service recess system according to claim 1,
wherein the contactlessly operating sensor system is further configured to detect a charging plug type of a charging plug or an operating fluid valve type of an operating fluid valve in the detection region of the sensor system, and
wherein the control facility is further configured, dependent upon the charging plug type or operating fluid valve type, to generate the at least one corresponding message and to output it via the interface and/or to actuate the at least one functional component of the charging, fueling, or service recess system.

5. The charging, fueling, or service recess system according to claim 2, wherein the control facility is further configured to actuate the actuator, dependent upon the charging plug type or operating fluid valve type, such that the recess body cover is transferred from its closed position into its open position; and/or
wherein the control facility is further configured to actuate the locking mechanism such that the locking mechanism is transferred into its state unlocking the recess body cover.

6. The charging, fueling, or service recess system according to claim 1,
wherein the contactlessly operating sensor system is configured to detect, at least indirectly, whether an AC charging plug or a DC charging plug is present in the detection region of the sensor system and wherein the control facility is configured, dependent upon the detection of an AC charging plug or a DC charging plug, to generate a corresponding message and to output it via the interface and/or to actuate the at least one functional component of the charging, fueling, or service recess system,
wherein the contactlessly operating sensor system is configured to detect whether a charging plug is one or more of the following:
a type 1 charging plug;
a type 2 charging plug;
a type 3 charging plug;
a CCS1 or combo1 plug;
a CCS2 or combo2 plug;
a CHAdeMO plug;
a Tesla supercharger charging plug; and/or
a GB/T charging plug.

7. The charging, fueling, or service recess system according to claim 2, wherein the control facility is further configured to actuate the actuator, dependent upon the detection of an AC charging plug or a DC charging plug, such that the recess body cover is transferred from its closed position into its open position.

8. The charging, fueling, or service recess system according to claim 4, wherein the contactlessly operating sensor system is configured to detect at least a charging plug type and, by means of the at least one feature detected, to draw a conclusion regarding a charging plug type.

9. The charging, fueling, or service recess system according to claim 1, wherein the contactlessly operating sensor system is configured to detect, at least indirectly, whether an operating fluid valve for fuel or an operating fluid valve for an additive is present in the detection region of the sensor system and wherein the control facility is configured to actuate the actuator, dependent upon the type of the operating fluid valve detected by the contactlessly operating sensor system, such that the recess body cover is transferred from its closed position into its open position,
wherein the contactlessly operating sensor system is configured to detect, at least indirectly, whether an operating fluid valve for diesel fuel or an operating fluid valve for gasoline fuel is present in the detection region of the sensor system and wherein the control facility is configured to actuate the actuator, dependent upon the operating fluid valve type detected by the contactlessly operating sensor system, such that the recess body cover is transferred from its closed position into its open position; or
wherein the contactlessly operating sensor system is configured to detect the diameter of an operating fluid valve situated in the detection region of the sensor system and, by means of the detected diameter, to draw a conclusion regarding an operating fluid valve type.

10. The charging, fueling, or service recess system according to claim 1, wherein the charging, fueling, or service recess system comprises at least one cover associated with the at least one terminal region or connecting region, said cover being able to be moved between a closed position, in which the at least one terminal region or connecting region is at least partially covered, and an open position in which the at least one terminal region or connecting region is accessible such that a charging plug or an operating fluid valve can be connected to the at least one terminal region or connecting region and/or can be received, at least partially, in the at least one terminal region or connecting region,
wherein the control facility is configured to actuate, dependent upon the charging plug type or the operating fluid valve type detected by the contactlessly operating sensor system, a detent associated with the cover and/or an actuator associated with the cover such that the cover is transferred from its closed position into its open position.

11. The charging, fueling, or service recess system according to claim 1,
wherein the charging, fueling, or service recess system comprises a contactlessly operating sensor system which is configured to detect whether, in a previously specified near field region surrounding the recess body cover, a hindrance or an object is present which could impede the transference of the recess body cover from its closed position into its open position, wherein the charging, fueling, or service recess system further comprises a control facility or wherein a control facility is associated with the charging, fueling, or service recess system, said control facility being configured, upon detection of a hindrance or an object in the near field region, to generate at least one corresponding message and to output it via an interface and/or to prevent an actuation of the at least one functional component of the charging, fueling, or service recess system, and in particular, to prevent a transference of the recess body cover from its closed position into its open position.

12. The charging, fueling, or service recess system according to claim 1,
wherein provided in the inner region of the recess body is a charging terminal apparatus for an electrically drivable vehicle, wherein the charging terminal apparatus comprises at least one charging terminal which serves as the terminal region and which is configured as a combined DC/AC charging terminal with AC contact elements and DC contact elements, wherein the charging, fueling, or service recess system comprises a cover which has a covering position and at least two uncovering positions, wherein the uncovering positions of the cover are each associated with a respective charging mode, wherein the cover comprises at least one movably mounted covering element which is able to move between a covering position and at least one uncovering position, wherein in a first uncovering position of the cover, the AC contact elements of the DC/AC charging terminal are uncovered and the DC contact elements of the DC/AC are covered by at least one covering element, wherein in the second uncovering position of the cover, the AC contact elements and the DC contact elements of the DC/AC charging terminal are uncovered,
wherein the contactlessly operating sensor system associated with the recess system is configured, dependent upon a charging plug type detected by the contactlessly operating sensor system, to set a position of the cover and, in particular, a position of the at least one covering element automatically.

13. The charging, fueling, or service recess system according to claim 1, wherein the contactlessly operating sensor system is configured to detect further states of the charging recess system.

14. The charging, fueling, or service recess system according to claim 1, wherein the contactlessly operating sensor system is constructed as an imaging sensor system and is configured to generate an at least two-dimensional image of an object present in the detection region of the sensor system,
wherein the contactlessly operating sensor system has an evaluating facility or wherein an evaluating facility is associated with the contactless operating sensor system, wherein the evaluating facility is configured to evaluate the at least two-dimensional image generated by the sensor system of the object such that the object is assigned to one of at least two classes, firstly one class which represents a charging plug or an operating fluid valve and, secondly a class for other or unidentified objects.

15. The charging, fueling, or service recess system according to claim 12,
wherein the evaluating facility is configured, for classifying the object from the at least two-dimensional image generated by the sensor system, to extract and/or evaluate a charging plug type,
wherein the evaluating facility is configured, on the basis of the recognized plug face of the charging plug, to assign the object to a class for a plug type selected from the following classes:
a type 1 charging plug;
a type 2 charging plug;
a type 3 charging plug;
a CCS1 or combo1 plug;
a CCS2 or combo2 plug;
a CHAdeMO plug;
a Tesla supercharger charging plug; and/or
a GB/T charging plug.

16. The charging, fueling, or service recess system according to claim 12,
wherein, in order to evaluate the at least two-dimensional image of the object generated by the sensor system, one or more of the following is used:
a neural network;
artificial intelligence;
a convolutional neural network;
a neural network involves a Single-Shot-Multibox-Detector network architecture that consists of at least five layers; and/or
supervised learning is utilized.

17. The charging, fueling, or service recess system according to claim 1, wherein an evaluating facility is provided which is configured to create, on the basis of external data, vehicle data and/or user data in the context of the profiling process, a pattern relating to the utilization behavior over time of the vehicle operator.

18. The charging, fueling, or service recess system according to claim 17, wherein a control facility is provided which is configured, dependent upon the pattern created, to generate in proactively and/or predictively at least one corresponding message and to output it via an interface, i and/or to actuate at least one functional component of the charging, fueling, or service recess system, wherein the control facility is configured, dependent upon the pattern created, to actuate an actuator of the recess body cover such that the recess body cover is transferred from its closed position into its open position, and/or to actuate a locking mechanism associated with the recess body cover such that the locking mechanism is transferred into a state unlocking the recess body cover, wherein the control facility is configured to actuate the actuator of the recess body cover, in particular, proactively and/or predictively, dependent upon the pattern created, such that the recess body cover is transferred from its closed position into its open position if the presence of a charging plug or an operating fluid valve in the detection region of the sensor system is detected by the contactlessly operating sensor system; or
wherein the evaluating facility is further configured, dependent upon the pattern created relating to the usage behavior over time of the vehicle operator, to generate a statistic and/or a corresponding message and to output it, in particular, to the vehicle operator and/or to the vehicle manufacturer and/or to output it to his sales partners, wherein the message contains a recommendation for an operation of the vehicle optimized, in particular, with regard to a saving of resources; or
wherein the evaluating facility is configured, in order to create the overall picture relating to the usage behavior over time of the vehicle operator during a learning or observation phase over at least one observation period and over a plurality of observation periods,
to establish a development over time of the usage of the vehicle; and/or
to establish a development over time of the consumption of resources by the vehicle; or
wherein the vehicle data and/or user data comprise, in particular, the following:
GPS data;
local time of the vehicle;
charging/fuel level of the vehicle; and/or
day of the week.

19. The charging, fueling, or service recess system according to claim 17, wherein the evaluating facility is further configured to make use of location data in combination with external data without usage behavior over time, for an activation of a charging plug recognition and/or a charging plug type recognition and/or for a charging plug recognition and/or a charging plug type recognition; or
wherein the evaluating facility is configured, according to a model-based method, to segment the at least two-dimensional image generated by the sensor system, wherein in the model-based method, at least one form that is specified in advance and is machine learnable, of the object contained in the at least two-dimensional image generated by the sensor system is assumed.

20. The charging, fueling, or service recess system according to claim 1, wherein associated with the recess body cover is a mechanism with an actuator which is configured to transfer the recess body cover from its closed position into its open position and, if necessary vice versa, as required, wherein the control facility is configured, upon detection by the contactlessly operating sensor system of the presence of a charging plug or an operating fluid valve, to actuate the actuator in such a way that the recess body cover is transferred from its closed position into its open position, wherein the actuator associated with the recess body cover is further configured, in particular, starting from the open position of the recess body cover to transfer the recess body cover from its open position into an intermediate position between the closed position and the open position, wherein the control facility is configured to detect whether a charging plug or an operating fluid valve is connected to the at least one terminal region or connecting region and/or is at least partially received in the at least one terminal region or connecting region, wherein furthermore, the control facility is configured to actuate the actuator associated with the recess body cover such that, in particular, starting from the open position of the recess body cover, the actuator moves the recess body cover from its open position into the intermediate position.
